(19) United States
(12) Patent Application Publication
(10) Pub. No.: US 2016/0353441 A1
(43) Pub. Date: Dec. 1, 2016

(54) POOLED RESOURCE CARRIER AGGREGATION

(71) Applicant: COMMSCOPE TECHNOLOGIES LLC, Hickory, NC (US)

(72) Inventors: Morgan C. KURK, Sachse, TX (US); Ray Kennth BUTLER, Allen, TX (US)

(21) Appl. No.: 15/117,096

(22) PCT Filed: Feb. 12, 2015
(86) PCT No.: PCT/US2015/015603

§ 371 Date: Aug. 5, 2016

Related U.S. Application Data
(60) Provisional application No. 61/939,034, filed on Feb. 12, 2014.

(51) Int. Cl. H04W 72/04; H04W 16/18

(52) U.S. Cl. CPC H04W 72/0453; H04W 16/18

(57) ABSTRACT

A wireless communication system having pooled Carrier Aggregation, according to one aspect of the present invention, includes a multi-sector cell site having a plurality of primary cells and at least one secondary cell. Each of the primary cells has a primary cell coverage area. The secondary cell has a coverage area that encompasses at least a substantial portion of each of the primary cell coverage areas of the plurality of primary cells. The secondary component carriers from the secondary cell may be aggregated with primary component carriers from each of the plurality of primary cells. Each of the plurality of primary cells comprises a sector of the multi-sector cell site, and the secondary cell provides omni-directional coverage for the cell site. In this example, each of the plurality of primary cells and the secondary cell comprise co-located eNodeBs. The omni-directional coverage provided by the secondary cell may comprise quasi-omnidirectional coverage provided by a plurality of antennas coupled to a single radio.

### RELATED APPLICATIONS

This application claims priority to and incorporates by reference U.S. Provisional Patent Application No. 61/939,034, filed Feb. 12, 2014 and titled “Pooled Resource Carrier Aggregation”

### FIELD OF THE INVENTION

The present invention relates generally to mobile wireless communications. In particular, the present invention relates generally to improvements in efficiencies in Carrier Aggregation.

### BACKGROUND

Aggregating multiple, narrower-bandwidth channels to form a higher bandwidth channel is known in the cellular industry. For example, the 3GPP technical specifications introduced “Dual-Cell” HSDPA (DC-HSDPA) in Release 8. With DC-HSDPA, two adjacent HSDPA channels are grouped together logically, permitting downlink transport blocks to be sent to the user equipment (UE) over both channels simultaneously. DC-HSDPA has been deployed in North America by a number of UMTS operators. Release 9 provided support for Multiple Input Multiple Output (MIMO) antenna systems and DC-HSDPA with noncontiguous channels and in different frequency bands.

Building upon DC-HSDPA, Carrier Aggregation, including aggregating adjacent and non-adjacent carriers, is a feature of LTE-Advanced (LTE-A) Release 10. Carrier Aggregation in wireless systems serves to increase bandwidth and data throughput for wireless data users. Release 10 permits the LTE radio interface to be configured with multiple radios of potentially different bandwidths and frequency bands. In LTE-A Release 11, PCells and SCells no longer need to be co-located or in the same frequency band. The use of Multiple Timing Advances is required for support of non-collocated cells. First, the UE is synchronized with a Pcell, then the UE has to synchronize with the SCell of the non-collocated site.

In an LTE Cell Site, the carrier where the User Equipment (UE) receives its system information is called the Primary Cell (Pcell). The Pcell is the cell that handles the Radio Resource Control (RRC) connection establishment. Every other configured carrier is referred to as a Secondary Cell (SCell). SCells can be activated and deactivated with respect to a given UE. PCells cannot be deactivated. Collectively, PCells and SCells are known as serving cells. The component carriers on which the PCell and Scell are based are the primary component carrier (PCC) and secondary component carrier (SCC), respectively. The component carriers provide the uplink and downlink paths.

When carriers are aggregated, the primary component carrier is the main carrier in any group. There will be a primary downlink carrier and an associated uplink primary component carrier. There may be one or more secondary component carriers. The aggregation of a primary and secondary carrier effectively doubles the frequency bandwidth available to that user. During data sessions, the primary carrier is always active, and secondary carriers may be added and dropped on an as-needed basis to increase throughput. Usage statistics show that a high throughput user is actually connected to both the primary carrier and the secondary carrier is less than 33% of the time. This results in considerable excess capacity for the SCells, driving up capital expense and operating expense for known Carrier Aggregation scenarios.

### SUMMARY OF THE INVENTION

A wireless communication system having pooled Carrier Aggregation, according to one aspect of the present invention, includes a multi-sector cell site having a plurality of primary cells and at least one secondary cell. Each of the primary cells has a primary cell coverage area. The secondary cell has a coverage area that encompasses at least a substantial portion of each of the primary cell coverage areas of the plurality of primary cells. The secondary component carriers from the secondary cell may be aggregated with primary component carriers from each of the plurality of primary cells. Each of the plurality of primary cells comprises a sector of the multi-sector cell site, and the secondary cell provides omni-directional coverage for the cell site. In this example, each of the plurality of primary cells and the secondary cell comprise co-located eNodeBs. The omni-directional coverage provided by the secondary cell may comprise quasi-omnidirectional coverage provided by a plurality of antennas coupled to a single radio.

In another example, the system may further include a base station having a baseband unit. The secondary cell may comprise a sector of a multi-sector cell site, and the primary cells may comprise DAS antennas that are not co-located with the secondary cell antenna. In this example, the eNodeB's driving the primary cells and the secondary cell are driven from the same baseband unit.

### BRIEF DESCRIPTION OF THE DRAWINGS

FIG. 1 is an illustration of a first example of a prior art LTE Cell Site.

FIG. 2 is an illustration of a second example of a prior art LTE Cell Site.

FIG. 3 is an illustration of an example of a LTE Cell Site having Carrier Aggregation according to a first example of the present invention.

FIG. 4 is an illustration of an example of DAS cells and a LTE Cell Site having Carrier Aggregation according to a second example of the present invention.

### DETAILED DESCRIPTION OF THE INVENTION

As used herein, the term “base station” may be considered synonymous to and/or referred to as a base transceiver station (BTS), NodeB, extended NodeB, evolved NodeB, femto cell, picocell, access point, etc. and may describe equipment that provides the radio baseband functions for data and/or voice connectivity between a network and one or more user equipments. The term “user equipment” (UE) may be considered synonymous to, and may hereafter be occasionally referred to, as a mobile, mobile unit, mobile station, mobile user, subscriber, user, remote station, access terminal, receiver, etc., and may describe a remote user of Wireless resources in a Wireless communication network.

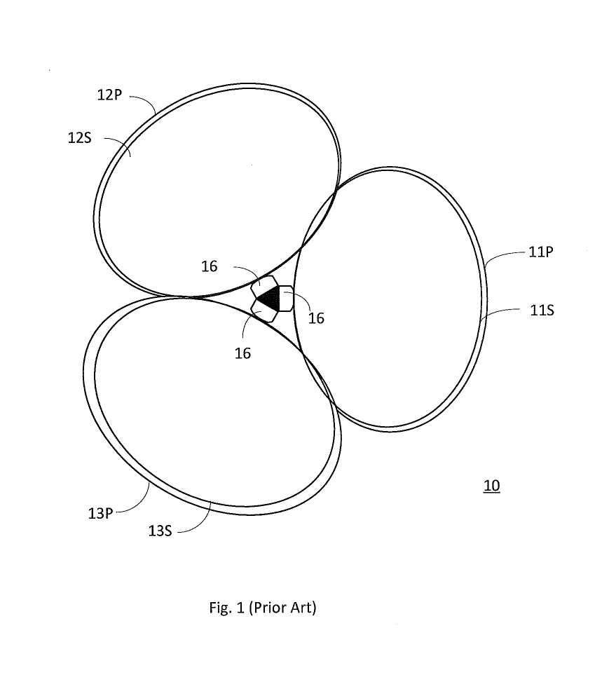

Various deployment scenarios have been suggested for Carrier Aggregation schemes. Referring to FIG. 1, one proposed Carrier Aggregation deployment scenario is illustrated. LTE Cell Site 10 includes three co-located antennas 16. In this scenario, the antennas 16 and the base stations associated with the antennas are in the same frequency band. The LTE Cell Site 10 generates two overlapping tri-sector coverage patterns. On the first tri-sector pattern, antennas 16 generate three PCells, 11P, 12P, 13P. In the second tri-sector pattern, antennas 16 also generate three SCells, 11S, 12S, 13S. The PCells and SCells provide roughly equal coverage and are overlaid with each other.

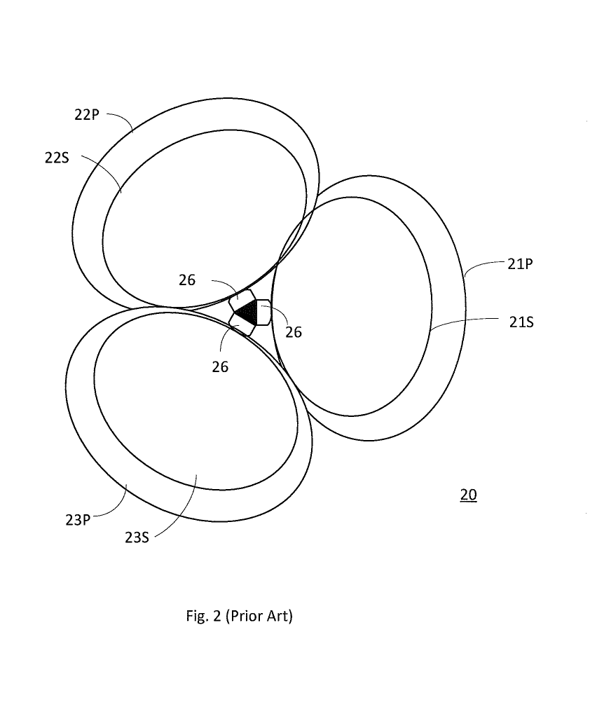

FIG. 2 illustrates a second proposed Carrier Aggregation deployment scenario where the antennas are co-located, but the carriers are in different frequency bands (e.g., a High Band and a Low Band). In the scenario of FIG. 2, an LTE Cell Site 20 includes three antennas 26, once again generating two tri-sector coverage patterns. Antennas 26 may comprise dual band antennas or separate single band antennas. The first tri-sector pattern includes PCells 21P, 22P and 23P. The second tri-sector pattern includes SCells 21S, 22S and 23S. PCells, 21P, 22P and 23P and SCells, 21S, 22S and 23S may be overlaid, but the frequency band providing the larger coverage area be assigned to PCells, 21P, 22P, 23P and the frequency band providing the smaller coverage area is assigned to the SCells, 21S, 22S, 23S.

Usage statistics from deployment scenarios such as above reveal that the percentage of time that a high throughput user is actually connected to both the primary carrier and the secondary carrier is less than 33% of the time. In other words, while the User Equipment is connected to the primary carrier 100% of the time, secondary carrier is aggregated in only about one third of the time. This means that current scenarios incur considerable excess capacity for the SCells, driving up capital expense and operating expense.

One aspect of the invention is to provide at a LTE Cell Site, one Scell having common, umbrella coverage over a plurality of PCells, with each PCell having a separate serving sector. This deployment scenario of the present invention takes advantage of the usage statistics concerning carrier aggregation that have been observed in the field. This deployment scenario enables pooled use of resources provided by the secondary carrier and provides maximum use of network resources.

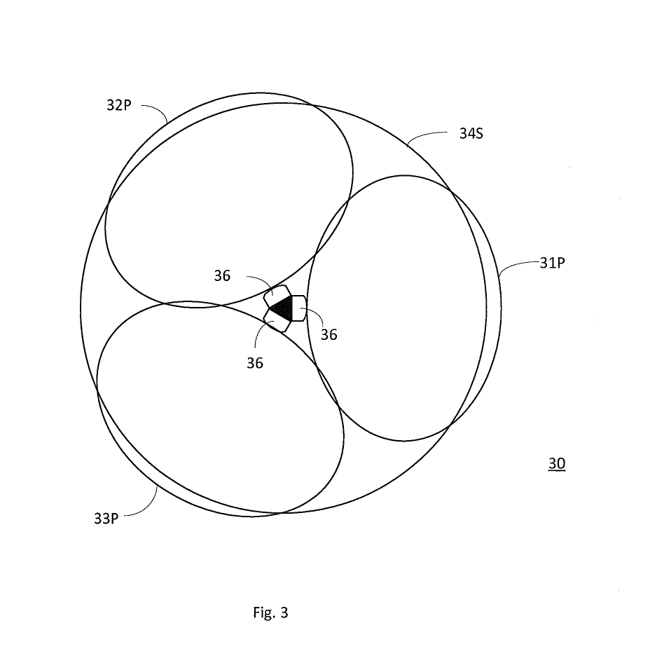

Referring to FIG. 3, a first aspect of the invention is illustrated. In this example, LTE Cell Site 30 includes a plurality of antennas 36, each serving a different sector. In the illustrated example, three antennas 36 serve three PCell sectors, 31P, 32P, and 33P. Greater or fewer PCells may be present at any given LTE Cellular Site. The PCells may comprise eNodeB base stations coupled to conventional 65° half power beamwidth (HPBW) antennas. LTE Site 30 also includes a single secondary carrier SCell 34S that provides coverage to approximately the same service area covered by the three PCells 31P, 32P, 33P combined. Even if each of the PCells 31P, 32P, 33P is nearing maximum capacity, because they aggregate in a secondary carrier from the SCell 34S only about 33% of the time, secondary carrier coverage provided by the single SCell is sufficient to meet traffic demands over the plurality of PCells.

The use of the Secondary Component Carrier and other network resources are thereby maximized. Also, fewer eNodeB base stations are required to provide secondary carrier coverage to the plurality of PCells, thereby reducing capital expense and operating expense for the LTE Cell Site 30.

This single umbrella carrier for SCell 34S may be transmitted and received using an omnidirectional coverage pattern. It is expected that the underlying sector carriers (the primary carriers) would carry the majority of traffic for each sector and that the umbrella carrier (secondary carrier) would only be used to address peak traffic conditions. While the example in FIG. 3 illustrates that the SCell has a coverage area approximately equal to the combined PCells, the invention is not so limited. For example, if the SCell is in a different frequency band than the PCell, the coverage area of the SCell may be smaller than the combined coverage areas of the PCells. Nevertheless, the SCell would encompass a substantial portion of each of the coverage areas of the PCells. In another example described below, the SCell may have a coverage area that is greater than the combined coverage areas of the PCells.

The omni-directional coverage pattern for the umbrella channel could be implemented with an omni-directional antenna, or could alternatively be implemented using sector antennas combined in a phased approach so as to provide a quasi-omni coverage pattern. See, for example, U.S. patent application Ser. No. 14/526,177, which is incorporated by reference. The existing antennas could be combined to provide this quasi-omni pattern using a cable harness with adjustable phase and group delay, so as to reuse existing antennas.

The present invention is not limited to three PCells and one SCell. The number of PCells may vary at individual LTE Cell Sites, and may include fewer or greater PCells. For example, six-sector sites are becoming more commonplace. Also, the number of PCells pooled with a single SCell may be adjusted to optimize equipment usage according to usage statistics at any given site. For example, a LTE Cell Site configured with six PCell sectors may be configured with one SCell covering all six PCells, two SCells covering three PCells apiece, or three SCells covering two PCells apiece.

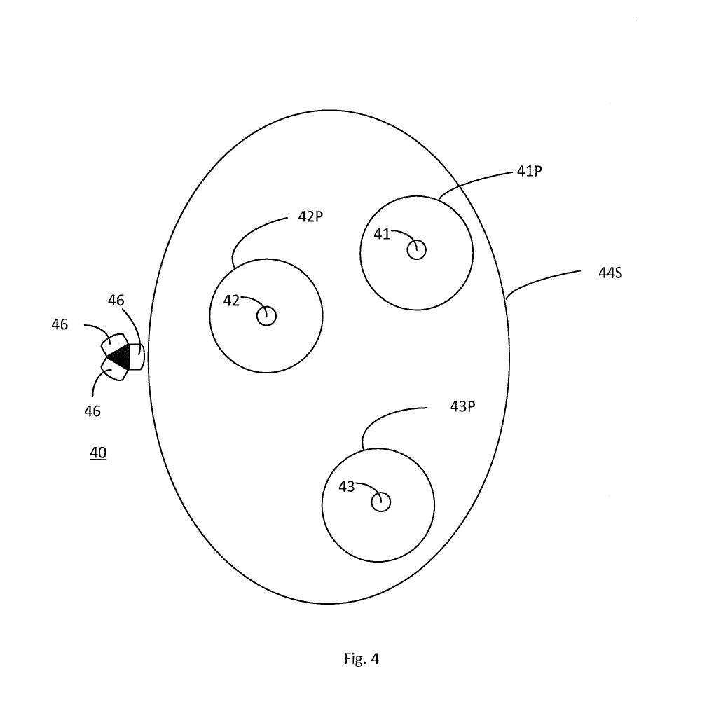

In another aspect of this invention, as illustrated in FIG. 4, a macro LTE Cell Site 40 provides an umbrella secondary carrier for multiple Distributed Antenna Systems (DAS). In the illustrated example, macro LTE Cell Site 40 provides a 65° sector antenna 46 from a macro base station site. The antenna 46 provides SCell 44S coverage for a 120° sector. Included with the SCell 44S are a plurality of DAS systems 41, 42, 43, each providing PCell 41P, 42P, 43P, respectively. PCells 41P, 42P, 43P comprise sub areas within the SCell 44S. The primary carriers provided by the DAS systems 41, 42, 43 may be aggregated with the secondary carriers provided by the SCell sector umbrella coverage from macro LTE Cell Site 40. The carriers of the DAS system comprise the PCells and the umbrella coverage provides a SCell for multiple PCells. While three DAS systems are illustrated in FIG. 4, the invention is not so limited. Greater or fewer DAS systems may be present within a given SCell.

The DAS cells are not co-located with the base station sector antenna. The eNodeB's driving the PCells and the SCells may be driven from a common baseband unit. In another example, the DAS systems and antenna 46 are associated with different eNodeBs. In this example, an X2 interface, or other suitable interface, may be provided between the two eNodeBs corresponding to antenna 47 and a given DAS system.

The base station antenna systems described herein and/or shown in the drawings are presented by way of example only and are not limiting as to the scope of the invention. Unless otherwise specifically stated, individual aspects and components of the antennas and feed network may be modified, or may have been substituted therefore known equivalents, or as yet unknown substitutes such as may be developed in the future or such as may be found to be acceptable substitutes in the future.

What is claimed is:

1. A multi-sector cell site, comprising:
a. a plurality of primary cells, each of the primary cells having a primary cell coverage area defining a sector of the multi-sector cell site; and
b. a secondary cell, the secondary cell having a coverage area that encompasses a substantial portion of each of the primary cell coverage areas of the plurality of primary cells;
wherein secondary component carriers from the secondary cell may be aggregated with primary component carriers from each of the plurality of primary cells.

2. The wireless communication system of claim 1 wherein the secondary cell provides omni-directional coverage for the cell site.

3. The wireless communication system of claim 2, wherein each of the plurality of primary cells and the secondary cell comprise co-located eNodeBs.

4. The wireless communication system of claim 2, wherein the omni-directional coverage comprises quasi omnidirectional coverage provided by a plurality of antennas coupled to a single radio.

5. The wireless communication system of claim 2, wherein the secondary cell has a coverage area approximately equal to the combined coverage areas of the plurality of primary cells.

6. The wireless communication system of claim 1 wherein the multi-sector cell site comprises a tri-sector cell site, and each of the plurality of primary cells comprises a sector of the tri-sector cell site, and wherein the secondary cell provides omni-directional coverage for the tri-sector cell site.

7. A multi-sector cell site, comprising:
a. a plurality of primary cells, each of the primary cells having a primary cell coverage area defining a sector of the multi-sector cell site; and
b. a secondary cell, the secondary cell having an omnidirectional coverage area that encompasses a substantial portion of each of the primary cell coverage areas of the plurality of primary cells;
wherein each of the plurality of primary cells and the secondary cell comprise co-located eNodeBs.

8. The wireless communication system of claim 7, wherein the omni-directional coverage comprises quasi-omnidirectional coverage provided by a plurality of antennas coupled to a single radio.

9. The wireless communication system of claim 7, wherein the secondary cell has a coverage area approximately equal to the combined coverage areas of the plurality of primary cells.

10. The wireless communication system of claim 7, wherein secondary component carriers from the secondary cell may be aggregated with primary component carriers from each of the plurality of primary cells.
